(19) United States
(12) Patent Application Publication
(10) Pub. No.: US 2005/0281729 A1
(43) Pub. Date: Dec. 22, 2005

(54) Method for manufacturing oxygen reduction electrode, oxygen reduction electrode and electrochemical element using same

(75) Inventors: Masa-aki Suzuki, Osaka (JP); Yuka Yamada, Nara-shi (JP); Nobuyasu Suzuki, Nara-shi (JP); Yasunori Morinaga, Osaka (JP); Hidehiro Sasaki, Osaka (JP); Tadashi Sotomura, Osaka (JP); Mitsuru Hashimoto, Yokohama-shi (JP); Masahiro Deguchi, Osaka (JP); Akira Taomoto, Kyotanabe-shi (JP); Toyokazu Ozaki, Nara-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD., Osaka (JP)

(21) Appl. No.: 11/178,496

(22) Filed: Jul. 12, 2005

Related U.S. Application Data
(63) Continuation of application No. PCT/JP04/08369, filed on Jun. 9, 2004.

(30) Foreign Application Priority Data
Nov. 6, 2003 (JP) 2003-166160

(51) Int. Cl. C01B 31/00

(52) U.S. Cl. 423/445 R

(57) ABSTRACT

It is an object of the present invention to provide an oxygen reduction electrode which provides four-electron reduction reaction with high selectivity in the reaction of reducing oxygen. The present invention involves a method of manufacturing an electrode for reducing oxygen used for four-electron reduction of oxygen, having (1) a first step wherein a charcoal-based material is obtained by carbonization of a starting material comprising a nitrogen-containing synthetic polymer, and (2) a second step wherein the electrode for reducing oxygen is manufactured using an electrode material comprising the charcoal-based material.

### TECHNICAL FIELD

The present invention relates to a method for manufacturing an oxygen reduction electrode to be used in reactions which reduce oxygen, to an electrode for reducing oxygen and to an electrochemical element which uses same.

### BACKGROUND ART

It is known that when oxygen (O₂) is reduced by electrolysis, one-electron, two-electron, or four-electron reduction takes place. A superoxide is generated in a one-electron reduction. In two-electron reduction, hydrogen peroxide is generated. Water is generated in four-electron reduction (for example, see Jacek Kipkowski, Philip N. Ross ed., Electrocatalysis, Wiley-VCH pub., 1998, pp. 204-205).

When the reduction of oxygen is used as the positive electrode reaction in a battery, it is necessary to obtain a battery or the like with high capacity, high voltage, and high output current. In this case, the requirements in the reduction of oxygen are that a) as many electrons be moved as possible, b) the potential be as electropositive as possible, and that c) overvoltage be reduceed as much as possible. In order to achieve this, a catalyst is preferably used that accelerates the four-electron reduction reaction at a high voltage potential and small overvoltage. One such catalyst is platinum (Pt).

However, platinum has such drawbacks as the following. (1) Platinum is a valuable noble metal and is not cost-effective. (2) Platinum is active not only in the reduction of oxygen, but also in the oxidation of ethanol, hydrogen, and other fuel substances, and is therefore poor in reaction selectivity. Because of this, oxidation reactions and reduction reactions must be isolated by a separator or the like in actual practice. (3) The surface of platinum is easily inactivated by carbon monoxide or hydroxyl groups, and high catalytic activity can be difficult to maintain.

Therefore, several attempts have been made thus far to develop a catalyst as a substitute for platinum.

For example, in Japanese Examined Patent Publication Nos. H2-030141 or H2-030142, a catalyst is proposed that consists of a fluororesin porous molded article and a conductive powder on which iron phthalocyanine, cobalt porphyrin, or other metal chelate compound possessing the ability to reduce oxygen gas is supported. It is also known that high oxygen reducing ability (four-electron reducing ability) can be achieved by using a dimer (binuclear complex) of a metal chelate compound, which can be applied to a high-output air battery.

For example, an oxygen-reducing catalyst technique is disclosed that uses a macrocyclic complex with Cr, Mn, Fe, Co, or another transition metal as the central metal thereof, such as a cobalt porphyrin binuclear complex or the like (Jacek Kipkowski, Philip N. Ross ed., Electrocatalysis, Wiley-VCH pub., 1998, pp. 232-234).

A manganese complex catalyst for oxygen reduction is disclosed in Japanese Unexamined Patent Publication No. H11-253811. This complex serves as a catalyst for performing four-electron reduction of oxygen with high selectivity. As described in this patent reference, a manganese atom goes from a valence of two to seven, and oxygen reduction is catalyzed in a potential range of from minus 0.5 V to plus 2 V.

The catalyst is often supported on a support that has excellent stability when these catalysts are actually used. When used in the electrode reaction of an electrochemical element, a carbon material is usually used as a conductive support. For example, carbon black, activated carbon, graphite, conductive carbon, vitreous carbon, and other carbon materials are used. These carbon materials are known to usually cause two-electron reduction and produce hydrogen peroxide in the electrolytic reduction of oxygen.

### DISCLOSURE OF THE INVENTION

However, a metal complex is needed whose central metal atom has a high valence if a high potential is to be obtained by using a catalyst such as those described above. Because this type of metal complex is highly reactive, drawbacks exist whereby reaction takes place with members that the metal complex is in contact with (for example, electrolytic solution, electrode leads, collectors, the battery case, separator, gas permselective film, and the like), which causes degradation of these members.

It is also known regarding the carbon material used as the support that palm nutshell activated carbon, wood charcoal, and the like have an ability to decompose hydrogen peroxide. For example, acrylic fiber charcoal, charcoals of beer lees, and the like have been disclosed as the types of activated carbon that have high performance as hydrogen peroxide decomposing catalysts (Japanese Unexamined Patent Publication Nos. H7-24315, 2003-1107, and others).

In addition, a button battery equipped with an air electrode comprising fibrous active charcoal made by carbonization of a natural resin such as coconut husk is disclosed in Japanese Unexamined Patent Publication No. S55-25916.

According to these documents, however, it is only the commonly known electrode reaction (so-called, two-electron reduction reaction) which is understood with respect to the catalytic reaction of the carbon material itself. Nothing in particular is disclosed regarding the catalytic action and usefulness as an electrode catalyst for a reduction of oxygen.

It is a principal object of the present invention to provide an oxygen reduction electrode which performs four-electron reduction reaction more selectively in the reaction of reducing oxygen.

It is another object of the present invention to provide a stable oxygen reduction electrode which exhibits virtually no oxidation activity with respect to fuel substances which are soluble in electrolytes.

The present invention relates to the following oxygen reduction electrode and electrochemical element which uses it.

1. A method for manufacturing an oxygen reduction electrode used in four-electron reduction of oxygen, the method comprising (1) a first step of obtaining a charcoal-based material by carbonizing a starting raw material comprising a nitrogen-containing synthetic polymer at a temperature of from 500° C. to 1000° C. in an atmosphere of 10% or less oxygen concentration by volume, and then subjecting the charcoal-based material to steam activation, and (2) a second step of producing the oxygen reduction electrode using an electrode material that contains the charcoal-based material.

2. The manufacturing method according to above 1, wherein the nitrogen-containing synthetic polymer is made from at least one kind of monomer having one or more nitrogen atoms in the molecule.

3. The manufacturing method according to above 1, wherein the nitrogen-containing synthetic polymer is at least one selected from the group consisting of a polyacrylonitrile, a polyimide, a polyamide, a polyurethane, a polyurea and a polyaniline.

4. The manufacturing method according to above 1, wherein the atmosphere is an inert gas atmosphere.

5. The manufacturing method according to above 1, wherein the oxygen reduction electrode is produced in the second step by forming the electrode material into a specific shape to obtain a formed body, and laminating or pressure-bonding the formed body to an electrically conductive base.

6. The manufacturing method according to above 1, wherein the oxygen reduction electrode is produced in the second step by preparing a paste containing the electrode material, and coating the paste onto an electrically conductive base.

7. The manufacturing method according to above 1, wherein an inorganic component is added to at least one of the starting material, the charcoal-based material and the electrode material.

8. The manufacturing method according to above 7, wherein the inorganic component comprises at least one selected from the group consisting of manganese, silicon, aluminum, phosphorus, calcium, potassium and magnesium.

9. The manufacturing method according to above 1, wherein the charcoal-based material exhibits the infrared absorption in the range of from about 3000 to 3500 cm⁻¹.

10. The manufacturing method according to above 9, wherein the infrared absorption is based on stretching of nitrogen (N)-hydrogen (H).

11. The manufacturing method according to above 1, wherein the charcoal-based material exhibits the infrared absorption in the range of from about 2000 to 2300 cm⁻¹.

12. The manufacturing method according to above 11, wherein the infrared absorption is based on stretching of carbon (C)-nitrogen (N) of nitrile.

13. The manufacturing method according to above 11, wherein the infrared absorption is based on stretching of nitrogen (N)=carbon (C)=nitrogen (N) of carbodiimide.

14. The manufacturing method according to above 11, wherein the infrared absorption is based on stretching of carbon (C)=nitrogen (N).

15. The manufacturing method according to above 1, wherein the charcoal-based material exhibits the infrared absorption in the range of from about 1600 to 1800 cm⁻¹.

16. The manufacturing method according to above 15, wherein the infrared absorption is based on stretching of nitrogen (N)-carbon (C)=oxygen (O) of amide or imide.

17. The manufacturing method according to above 1, wherein the charcoal-based material exhibits 1) the infrared absorption in the range of from about 3000 to 3500 cm⁻¹, 2) the infrared absorption in the range of from about 2000 to 2300 cm⁻¹ and 3) the infrared absorption in the range of from about 1600 to 1800 cm⁻¹.

18. The manufacturing method according to above 1, wherein at least one type of metal and oxide thereof is added to at least one of the starting material, the charcoal-based material and the electrode material.

19. The manufacturing method according to above 18, wherein the oxide is a lower oxide of manganese represented by the general formula MnO_{y}, wherein y is a number of oxygen atoms determined by the valence of manganese (Mn), and is less than two.

### BRIEF DESCRIPTION OF THE DRAWINGS

FIG. 1 shows the voltage (electromotive force)—current characteristics of test electrodes 1 and 2 and the respective comparative electrodes with respect to an oxygen reduction reaction.

FIG. 2 shows the voltage (electromotive force)—current characteristics of test electrodes 3, 4, 5 and 6 and the respective comparative electrodes with respect to an oxygen reduction reaction.

FIG. 3 is a cross-sectional view of the three-electrode cell which is measured in one example of the present invention.

FIG. 4 is a cross-sectional view of the power-generating cell of another example of the present invention.

### LIST OF ELEMENTS

1 air electrode
1a air electrode mixture
1b fluororesin porous sheet
1c electrode lead
2 counter electrode
3 reference electrode
4 electrolyte
5 glass cell
6 glass substrate
7 ITO thin film
8 TiO₂ fine particle thin film
9 dye molecule layer
10 electrolyte/fuel liquid
11 air electrode
12 oxygen-permeable water-repelling film
13a electrolyte/fuel inlet
13b electrolyte/fuel outlet
14a, 14b fluid valves
15 negative electrode lead
16 positive electrode lead
17 seal

### BEST MODE FOR CARRYING OUT THE INVENTION

1. Method for Manufacturing an Oxygen Reduction Electrode

The oxygen reduction electrode of the present invention is produced by a manufacturing method comprising (1) a first step of obtaining a charcoal-based material by carbonizing a starting raw material comprising a nitrogen-containing synthetic polymer, and (2) a second step of producing the oxygen reduction electrode using an electrode material that contains the charcoal-based material.

(1) First Step

In the first step, a charcoal-based material is obtained by carbonizing a starting raw material which comprises a nitrogen-containing synthetic polymer

Starting Material

The starting raw material comprises at least a nitrogen-containing synthetic polymer. There are no limits on the nitrogen-containing polymer (hereunder sometimes called simply “synthetic polymer”) as long as it becomes a charcoal-based material containing nitrogen when subjected to carbonization treatment. Because it is a synthetic polymer, however, biologically-derived polymers are not included.

Polymers (including oligomers) obtained using one or two or more kinds of monomer having one or more nitrogen atoms in the molecule are used favorably as the synthetic polymer. It is desirable to use at least one of a polyacrylonitrile, a polyimide(including polyamidimide), a polyamide, a polyurethane, a polyurea and a polyaniline as such a synthetic polymer. Those which have aromatic molecular structures can be used by preference from the standpoint of ease of charcoal-based material generation. Known or commercial polymers can be used for these nitrogen-containing polymers.

Of these, it is particularly desirable to use at least one of a polyacrylonitrile, a polyimide and a polyamide in the present invention.

Because the principal constituent unit of a polyacrylonitrile is acrylonitrile, not only is the nitrogen content per repeating unit of polymer high, but also carbonization progresses easily as nitrogen is incorporated into the carbon component in a reaction accompanied by cyclization of the nitrile groups by heating. Consequently, many functional groups containing nitrogen are present in the carbon component, allowing the desired effects to be obtained more reliably.

The polyacrylonitrile may be not only a polymer of 100% polyacrylonitrile, but also a copolymer having acrylonitrile as the principal component or a mixture of these polymers with another polymer. Examples of acrylonitrile copolymers include copolymers of acrylonitrile with acrylamide, acrylic acid, acrylic acid ester, methacrylic acid, methacrylic acid ester, styrene, butadiene and the like.

In addition to those generally classified as polyimides, the polyimide polymer encompasses synthetic polymers such as polyamidimide, polyetherimide and the like having an imide ring structure in the principal chain. Because in these polymers carbonization progresses from the imide ring part and the carbonized part contains nitrogen, they can be used favorably as the synthetic polymer of the present invention.

A polyimide is usually synthesized by a condensation polymerization reaction of a dicarboxylic anhydride compound and a diamine compound. In this reaction process synthesis normally occurs via polyamic acid, which is an intermediate polyimide precursor, and polyamic acid can be used as the precursor of the charcoal-based material. The molecular structure of the polymer is determined by the selection of raw material compounds, and aromatic raw materials or those with a cyclic structure are desirable for forming the charcoal-based material.

For example, pyromellitic anhydride, bisphenyltetracarboxylic dianhydride, benzophenonetetracarboxylic dianhydride, 4,4′-hexafluoroisopropylidene bis(phthalic anhydride), cyclobutanetetracarboxylic dianhydride, 2,3,5-tricarboxycyclopentylacetic dianhydride and the like for example can be used as the aforementioned dicarboxylic anhydride compound. Moreover, examples of the aforementioned diamine compound include paraphenylene diamine, meta phenylene diamine, 2,4-diaminotoluene, bis(4-aminophenyl)ether, 4,4′-diaminodiphenylmethane, 4,4′-diaminotriphenylmethane, 2,2-bis(4-aminophenyl)-hexafluoropropane, 4,4′-diamino-4″-hydroxytriphenylmethane, 3,3′-dihydroxy-4,4′-diaminobiphenyl, 2,2-bis(3-amino-4-hydroxyphenyl)-hexafluoropropane, 3,5-diaminobenzoic acid and the like.

In addition to those ordinarily classified as polyamides, the polyamide polymer encompasses synthetic polymers such as polyamidimide, polyetheramide and the like having amide groups in the principal chain. These can be used favorably because carbonization progresses from the amide groups and nitrogen is contained in the carbonized part. Polyamide polymers are generally synthesized by a condensation polymerization reaction of a carboxylic acid compound and an amine compound.

Examples of carboxylic acid compounds having two polymerization reaction groups include adipic acid, succinic acid, phthalic acid, maleic acid, terephthalic acid and the like. Examples of those having three or more polymerization reaction groups include tricarballylic acid, trimesic acid (1,3,5-benzenetricarboxylic acid), 1,2,4-benzenetricarboxylic acid, pyromellitic acid, bisphenyltetracarboxylic acid, benzophenonetetracarboxylic acid, 4,4′-(hexafluoroisopropylidene)bis phthalic acid, cyclobutanetetracarboxylic acid, 2,3,5-tricarboxycyclopentylacetic acid and the like. In addition, a halide of the aforementioned acid compounds, and particularly an acid chloride compound can be used.

Examples of amine compounds having two polymerization reaction groups include hexamethylenediamine, nonamethylenediamine, paraphenylenediamine, metaphenylenediamine, 2,4-diaminotoluene, bis(4-aminophenyl)ether, 4,4′-diaminodiphenylmethane, 4,4′-diaminotriphenylmethane, 2,2-bis(4-aminophenyl)-hexafluoropropane, 4,4′-diamino-4″-hydroxytriphenylmethane, 3,3′-dihydroxy-4,4′-diaminobiphenyl, 2,2-bis(3-amino-4-hydroxyphenyl)-hexafluoropropane, 3,5-diaminobenzoic acid and the like. Those having three or more polymerization reaction groups include for example melamlne, diaminobenzidine and the like.

Of these three kinds of nitrogen-containing synthetic polymers, a polyacrylonitrile polymer is most desirable in the present invention.

There are no limits on the form of the synthetic polymer, and carbonization can be performed on any form including fiber, particles, powder, sheets, slices or the like. Moreover, because this synthetic polymer can be a waste product created from production for another purpose or may be collected after use as a product, the benefit of recycling of a waste product is obtained. For example, this can be applied to recycling of acrylic fiber or the like.

In the present invention, other additives can be mixed with the starting raw material as necessary. The amounts added can be determined appropriately according to the type of additive and the like.

For example, a binder such as an organic binder (polyvinyl alcohol, butyral resin or the like) or an inorganic binder (silicic anhydride or the like) can be added in order to improve the handling properties of the charcoal-based material.

In addition, a solvent can be mixed with the starting raw material. For example, an organic solvent of phenol or a phenol derivative (such as mononitrophenol, dinitrophenol, trinitrophenol, resorcinol, 1,4-di-hydroxybenzene, m-cresol, p-cresol or the like) can be used.

Carbonization and Activation

A charcoal-based material is made by carbonizing the aforementioned starting raw material. Normally a charcoal-based material can be obtained by heat treating the synthetic polymer. The heat treatment conditions can be set appropriately according to the type of synthetic polymer used, the properties of the desired charcoal-based material and the like.

The heat treatment temperature can be set within the range of normally no less than 300° C. and no more than about 1200° C. Because graphitization progresses above 1200° C., a temperature of 1200° C. or below is desirable for treatment. A range of no less than 500° C. and no more than 1000° C. is preferred. Better conductivity can be obtained at 500° C. and above. At 1000° C. or less, the carbon (C) nitrogen (N) nitrile bond(s), nitrogen (N)=carbon (C)=nitrogen (N) carbodiimide bond(s) and carbon (C)=nitrogen (N) bond(s) described below and the like can be made to persist within the carbon component, so that oxygen reduction activity can be achieved and the reaction performed efficiently.

The heat treatment time can be set appropriately according to the heat treatment temperature, the type and amount of synthetic polymer used and the like so that carbonization progresses satisfactorily.

The heat treatment atmosphere is preferably set so that the oxygen concentration is low, or oxygen is substantially absent in order to prevent the synthetic polymer from combustion when heated to about 300° C. or more. Specifically, an atmosphere having an oxygen concentration of 10% or less by volume or more particularly 1% or less by volume is desirable. An inert gas atmosphere (nitrogen, argon, helium or the like) or a vacuum is especially desirable.

It is desirable to subject the resulting charcoal-based material to activation treatment after carbonization. Through activation the specific surface area of the charcoal-based material can be increased to enhance the activity, affinity for the object of reaction can be improved, affinity for other materials to be supported can be improved, and the acidity of the surface can be adjusted.

Activation can be carried out according to known methods. For example, 1) gas activation using steam, carbon dioxide or the like or 2) chemical activation using ammonium chloride, zinc chloride, potassium hydroxide or the like can be employed. The activation temperature differs depending on the treatment method. In the case of gas activation for example, the temperature may be similar to that for the aforementioned carbonization treatment. In the case of chemical activation, the charcoal-based material can be treated at room temperature or, after being exposed to the chemical, can be treated within a range up to a temperature similar to that for the aforementioned carbonization.

(2) Second Step

In the second step, an electrode is manufactured using an electrode material comprising the aforementioned charcoal-based material.

Charcoal-Based Material

In general, the charcoal-based material contains organic components having a structure derived from the synthetic polymer used (type of monomer, molecular weight and the like).

In particular, the desired effects of the present invention are obtained when the carbon component of the charcoal-based material is non-crystalline and conductive and has a structure derived from the molecular structure before carbonization. In particular, a structure derived from the nitrogen in the synthetic polymer is effective. Such as structure differs depending on the type of nitrogen-containing synthetic polymer used and the like. Consequently, in the charcoal-based material of the present invention a variety of functional groups are also produced in the process of carbonization depending on the type of synthetic polymer and the like. As a result, a structure derived from that synthetic polymer can be confirmed as absorption resulting from the characteristic absorption of an infrared absorption spectrum. Examples include the nitrogen (N)-hydrogen (H) stretching vibration in a wave number range of from about 3000 cm⁻¹ to 3500 cm⁻¹; the carbon (C) nitrogen (N) nitrile stretching vibration, nitrogen (N)=carbon (C)=nitrogen (N) carbodiimide stretching vibration and carbon (C)=nitrogen (N) stretching vibration and the like in a wave number range of from about 2000 cm⁻¹ to 2300 cm⁻¹; and the nitrogen (N)-carbon (C)=oxygen (O) amide or imide stretching vibrations and the like in a wave number range of from about 1600 cm⁻¹ to 1800 cm⁻¹. This feature is not observed in other active carbon, carbon black or the like.

By using a charcoal-based material comprising components exhibiting such absorption it is possible to more effectively improve the electrode characteristics. In the composition of a charcoal-based material made from the synthetic polymer, carbon is contained as the main component. The carbon component may be either crystalline or non-crystalline, but is preferably non-crystalline. The aforementioned carbon component may be conductive preferably.

In the present invention, inorganic components can be deliberately added to the charcoal-based material. Better characteristics can be achieved through the addition of inorganic components. In the present invention it is particularly desirable to add at least one of manganese, silicon, aluminum, phosphorus, calcium, potassium and magnesium. These inorganic components may be in the form of oxides, phosphates, carbonates and the like. Inorganic components may be added so that the total content is 10% or more by mass or particularly 20% or more by mass of the charcoal-based material. This is also different from activated charcoal, carbon black and the like in which the total content of inorganic components is a few percent by mass. The lower limit of content of inorganic components may be determined appropriately depending on the characteristics and the like but is normally about 5% by mass.

The content of the inorganic component is measured as the ash content when the charcoal-based material is put through CHN elemental analysis. The elemental quantity can be measured by X-ray fluorescence elemental analysis, ion chromatography analysis, and the like.

The inorganic components can be either added to the charcoal-based material or blended with the starting raw material or electrode material.

The form of the charcoal-based material is not limited insofar as it has such properties as described above, but the charcoal-based material is preferably in particle or powder (granular) form. When the charcoal-based material is in powder or granular form, the particle size is preferably such that it can pass through a Tyler sieve of 200 mesh or higher. Furthermore, it is particularly preferred that the maximum particle size (diameter) be 20 μm or less, more preferably from 1 μm to 20 μm. The reduction reaction generally occurs on the surface of the particle, so the effectiveness with respect to the quantity used may decline if the diameter exceeds 20 μm. A publicly known grinder, classifier, or the like may be used to adjust the particle size.

Electrode Material

The electrode is fabricated using an electrode material that contains the above-mentioned charcoal-based material. Various materials can be admixed into the electrode material as needed to enhance electrode characteristics and the like. These materials can also be admixed in advance into the starting material in a range that does not adversely affect the performance of the present invention.

For example, at least one type of metal and oxide thereof can be admixed therein in order to further raise the ability to take in and release oxygen (oxygen exchange capability). Examples thereof include Mn₂O₃, Mn₃O₄, Mn₅O₈, γ-MnOOH (mixture of Mn₃O₄ with Mn₅O₈), and other lower oxides of manganese MnO_{y} (where y is the number of oxygen atoms determined by the valence of manganese, and is less than 2); ruthenium oxide, Cuₓ₋₁SrₓTiO₃ (x=0 to 0.5), LaₓSr₁₋ₓMnO₃ (x=0 to 0.5), SrTiO₃, and other perovskite oxides; as well as vanadium oxide, platinum black, and the like.

Among these, lower oxides of manganese are preferred in terms of their high hydrogen peroxide decomposition activity, low degradation, and low cost. The term “lower oxide of manganese” refers to a manganese oxide in which the valence of the manganese atom is less than four. This is particularly preferred also from the standpoint of effective use of resources, because the manganese dioxide positive electrode of a used manganese dry cell can be used in unmodified form, or a calcined product may be used, for example.

Moreover, polyphosphoric acid, potassium hydrogenphosphate, magnesium carbonate, calcium carbonate, potassium hydrogencarbonate, silicon oxide, aluminum oxide or the like can also be blended with the electrode material. A silica gel, silica xerogel or silica aerogel having silicon oxide as the main component or an aluminosilicate such as a zeolite compound or the like can also be added to the electrode material. Zeolites are particularly effective for promoting reactions because they have pores of a few angstroms in size and a high specific surface area.

These inorganic compounds may be added to the electrode material but may also be blended with the starting raw material or the charcoal-based material. When blending with the starting raw material, for example the nitrogen-containing synthetic polymer can be powdered and then made into liquid form using a pitch or solution of phenol or a phenol derivative (such as mononitrophenol, dinitrophenol, trinitrophenol, resorcinol, 1,4-di-hydroxybenzene, m-cresol, p-cresol and the like), and a powder of the desired inorganic compound or a solution of the dissolved inorganic compound can then be added to the liquid and the resultant mixture may be carbonized.

The added quantity of the above-mentioned metal or an oxide thereof can be appropriately determined according to the type, desired electrode characteristics, and other aspects of the metal or oxide used, but the added quantity is preferably set in a range of from 1 wt % to 50 wt %, particularly from 5 wt % to 20 wt %, in the electrode ultimately obtained.

Various other additives can also be admixed into the electrode material. Additives can be used, for example, to 1) adjust affinity for another material, 2) adjust the surface (electrode surface) acidity, 3) impart catalytic activity, 4) provide co-catalyst, 5) reduce overvoltage, and for other purposes. Organic materials, inorganic materials, composites thereof, mixtures thereof, and the like can all be used as this type of additive according to the purpose of the additive as described above. More specifically, it is possible to use platinum, cobalt, ruthenium, palladium, nickel, gold, silver, copper, platinum-cobalt alloy, platinum-ruthenium alloy, and other metals or alloys; graphite, activated carbon, and other carbon materials; copper oxides, nickel oxides, cobalt oxides, ruthenium oxides, tungsten oxides, molybdenum oxides, manganese oxides, lanthanum-manganese-copper perovskite oxides, and other metal oxides; iron phthalocyanine, cobalt phthalocyanine, copper phthalocyanine, manganese phthalocyanine, zinc phthalocyanine, and other metal phthalocyanines and metal porphyrins having a porphyrin ring; ruthenium ammine complexes, cobalt ammine complexes, cobalt ethylene diamine complexes, and other metal complexes and the like.

The central metal elements mentioned for the metal complexes are not limiting, but at least one type of platinum, ruthenium, cobalt, manganese, iron, copper, silver, or zinc is particularly preferred. The reduction of oxygen can be accelerated with a smaller overvoltage by using these metal elements. It is also preferred that the valence of the metal element be four or lower. The oxidizing power of the catalyst can be more effectively reduced if the valence is four or lower. As a result, oxidative degradation of the structural elements of the electrochemical element (for example, electrolyte, electrode leads, collector, battery case, separator, gas permselective film, and the like) can be effectively prevented.

The added quantity of the above-mentioned additives can be appropriately determined according to the type of material used, the desired electrode characteristics, and the like, but the added quantity is preferably set in a range of from 1 wt % to 80 wt %, particularly from 20 wt % to 60 wt %, in the electrode ultimately obtained.

The above-mentioned electrode material may contain a material that is commonly added to a publicly known electrode material. For example, polytetrafluoroethylene, Nafion, or other fluororesin binder; polyvinyl alcohol, polyvinyl butyral or other resin binder; graphite, electrically conductive carbon, hydrophilic carbon black, hydrophobic carbon black, or other electrically conductive agent or the like may be appropriately added as necessary.

Electrode Fabrication

The electrode may be manufactured according to a publicly known electrode manufacturing method using the above-mentioned electrode material. For example, fabrication may be carried out by a method whereby a pre-fabricated molding of the electrode material is laminated or pressed onto an electrically conductive base (collector); a method whereby a paste containing the electrode material is coated onto an electrically conductive base; a method whereby an electrically conductive material is mixed with the electrode material and molded; or by another method.

The following materials can be advantageously used for the above-mentioned electrically conductive base: carbon paper manufactured from carbon fiber; stainless steel mesh, nickel mesh, or other metal mesh; an electrically conductive composite sheet in which carbon powder, metal powder, or the like is bound by a fluororesin or other synthetic resin binder and machined into a sheet; or the like.

The above-mentioned paste can be prepared by dissolving the binder in an appropriate solvent. For example, when polytetrafluoroethylene is used as the binder, ethanol or another alcohol can be used as the solvent. The concentration of the binder may be appropriately determined according to the type and other attributes of the binder.

2. Oxygen Reduction Electrode

The present invention also encompasses an oxygen reduction electrode that is obtained by the manufacturing method of the present invention. Specifically, the invention encompasses an oxgen reduction electrode used for four-electron reduction of oxygen, wherein the electrode comprises a charcoal-based material obtained by carbonizing a starting material comprising a nitrogen-containing synthetic polymer. The components described previously may be employed as the starting raw material and other constituent elements in the electrode pertaining to the present invention.

The quantity of the charcoal-based material contained in the oxygen reduction electrode of the present invention is not limited, and may be appropriately determined according to the application, purpose for use, and other aspects of the electrode. Particularly, it is preferable that the electrode contain the charcoal-based material in a ratio of from 1 wt % to 80 wt %, particularly from 20 wt % to 60 wt %. Better four-electron reduction performance can be obtained by setting this content within this range.

The following reactions occur when the oxygen reduction electrode of the present invention is used as the positive electrode of a cell.

In the oxygen reduction electrode of the present invention, the two-electron reduction reaction (1) of oxygen indicated by the formula: O₂+H₂O+2e⁻→OH⁻+HO²⁻ (in an alkaline solution) occurs and hydrogen peroxide is generated (H₂O₂; hydrogen peroxide ion indicated by the formula HO²⁻ in an alkaline solution). Furthermore, the hydrogen peroxide ion thus generated brings about the decomposition reaction (2) indicated by the formula: 2HO²⁻→O₂+2OH⁻, and oxygen is again generated. This oxygen again undergoes two-electron reduction, and a hydrogen peroxide ion is generated.

One molecule of oxygen generates one hydrogen peroxide ionic molecule by two-electron reduction reaction (1). One molecule of the hydrogen peroxide ion thus generated yields one-half (½) molecule of oxygen by the decomposition reaction (2). The one-half molecule of oxygen generates one-half hydrogen peroxide ionic molecule by the two-electron reduction reaction (1). The one-half peroxide ionic molecule thus generated regenerates one-fourth molecule of oxygen by the decomposition reaction (2). The one-fourth molecule of oxygen generates one-fourth hydrogen peroxide ionic molecule by two-electron reduction reaction (1). The one-fourth peroxide ionic molecule thus generated yields one-eighth molecule of oxygen by the decomposition reaction (2). Two-electron reduction reaction (1) and decomposition reaction (2) occur repeatedly in this fashion.

Specifically, 2 electrons, 1 electron, ½ electron, ¼ electron, ⅛ electron, . . . , (½)n electron (n→infinity) for a total of 4 electrons are used to reduce one molecule of oxygen, which is essentially the same as one oxygen molecule undergoing four-electron reduction at the potential of two-electron reduction. In other words, the result is the same as if the reaction were O₂+2H₂O+4e⁻→4OH⁻.

From the standpoint of the functions of a charcoal-based material formed by carbonization of a starting material comprising a nitrogen-containing synthetic polymer (encompassing particularly cases in which an inorganic component is contained), the two-electron reduction reaction of oxygen molecules first occurs in the carbon components, with hydrogen peroxide being produced at the same time. It is possible that the resulting hydrogen peroxide is broken down by neighboring inorganic components or functional parts which contain the aforementioned nitrogen. Moreover, it is considered that the oxygen produced in this reaction substantially undergoes four-electron reduction reaction due to successive repetition of the two-electron reduction reaction by neighboring carbon components. It is possible that such a reaction occurs because the carbon component is located extremely close to the inorganic component or functional part containing nitrogen, which acts to degrade hydrogen peroxide in the carbon component. It is likely that various active states are present in the carbon component, or else the inorganic component mixed with the carbon component assumes various oxidation states, thus enhancing oxygen exchange ability and promoting decomposition of the hydrogen peroxide.

It is also possible that in proximity with the carbon component, these also promote the two-electron reduction reaction because affinity for water and hydrogen peroxide is higher in addition to a high affinity for oxygen. Moreover, it is also conceivable that because the inorganic component is also present in an oxidized state, it serves as a co-catalyst to promote the reaction. The porosity of the carbon component or inorganic component may also have an effect, increasing the specific surface area by means of pores in the various reaction sites so that the object of reaction collects at higher concentrations and the reaction becomes more active. In any case, it appears that four-electron reduction reaction progresses with great selectivity due not to the individual effects of the various components and reaction sites but to a synergistic function.

The oxygen reduction electrode of the present invention is thus capable of giving a pathway for the reduction of oxygen to an electrochemical reduction with oxygen as the electrode reacting substance, and initiating four-electron reduction reaction with high selectivity (selectivity near 100%) by means of the electrochemical catalyst action of a charcoal-based material obtained by carbonizing a nitrogen-containing synthetic polymer.

The profitable effects of the present invention are achieved with a reduction reaction of oxygen which is greater than two-electron, and preferably four-electron reduction reaction if possible. For practical purposes, as a replacement for platinum catalysts, at least three-electron reduction reaction and especially a reduction reaction in the range of from 3.5-electron to 4-electron is desirable because performance equivalent to that of platinum can be obtained. The number of electrons in the oxygen reduction reaction can be ascertained by the rotating ring electrode method.

3. Electrochemical Element

The electrochemical element of the present invention has a) a positive electrode for the positive electrode reaction in the reduction of oxygen, b) a negative electrode, and c) an electrolyte, wherein the positive element contains a charcoal-based material formed by the carbonization of a nitrogen-containing synthetic polymer.

Specifically, the electrode pertaining to the present invention is basically used as the positive electrode in the electrochemical element of the present invention. Platinum, zinc, magnesium, aluminum, iron, or another publicly known electrode, for example, can be used as the negative electrode.

In the electrochemical element of the present invention, apart from using the oxygen reduction electrode of the present invention as the positive electrode, constituent elements of a publicly known electrochemical element may also be employed. For example, publicly known or commercially available components may be used for the electrolyte, separator, vessel, electrode leads, and the like.

Particularly, the electrolyte may consist of either an electrolyte solution or a solid electrolyte, but the use of an electrolyte solution is particularly appropriate. When an electrolyte solution is used, its solvent may be either water or an organic solvent. An aqueous solution is preferably used as the electrolyte solution. The pH of the electrolyte solution is not limited, but a neutral range from pH 6 to pH 9 is particularly preferred. Use of a neutral aqueous solution as the electrolyte is preferred in the present invention because higher activity is thereby obtained.

The electrolyte preferably contains a fuel substance. It is particularly preferred that the fuel substance be dissolved in the neutral aqueous solution. The negative electrode reaction preferably consists of an oxidation reaction that electrochemically removes one or more electrons from the fuel substance dissolved in the electrolyte. The above-mentioned fuel substance is not particularly limited insofar as it is soluble in the electrolyte used (particularly in a neutral aqueous solution), but preferably consists of at least one type of sugar or alcohol. Examples of sugars include glucose, fructose, mannose, starch, cellulose, and the like. Examples of alcohols include methanol, ethanol, propanol, butanol, glycerol, and the like.

The content (concentration) of the fuel substance in the electrolyte depends on the type of fuel used, the type of solvent, and other aspects, but a content of from about 0.01 wt % to about 100 wt %, particularly from 1 wt % to 20 wt %, is generally preferred.

In the electrochemical element of the present invention, the electrode is preferably placed and used in a location in which contact is established between three phases consisting, for example, of 1) a gas containing oxygen, 2) a liquid composed of an electrolyte solution, and 3) a solid composed of an electrical conductor. By placing the electrode of the present invention (particularly the charcoal-based material) at the intersection of the ion path and the electron path, it becomes possible to smoothly induce electrochemical reduction of oxygen at a small overvoltage (resistance), and a large current value can be obtained.

The oxygen reduction electrode of the present invention has almost no oxidizing activity with respect to the sugar or alcohol that is the electrolyte-soluble fuel. A power-generating cell can therefore be constructed by using the electrode of the present invention as the plus terminal (positive electrode), a solution of a sugar or an alcohol as the electrolyte, and a minus terminal (negative electrode) for oxidizing the sugar or alcohol. In this case, even if the positive electrode side is not isolated from the negative electrode side by a separator, the voltage of the power-generating cell does not decline even if the sugar or alcohol that is the fuel dissolved in the electrolyte comes into direct contact with the positive electrode. A separator may, of course, be used as needed in the electrochemical element of the present invention.

Four-electron reduction of oxygen such as was described previously is initiated because an electrode containing a charcoal-based material obtained from the carbonization of a nitrogen-containing synthetic polymer is used as the positive electrode in the electrochemical element of the present invention. In other words, four-electron reduction reaction can be performed by using the electrochemical element of the present invention.

### ADVANTAGES OF THE INVENTION

According to the electrode of the present invention, an electrode can be obtained that is capable of efficient electrochemical reduction of oxygen by using a charcoal-based material formed by carbonizimg a nitrogen-containing synthetic polymer.

Specifically, the electrode of the present invention demonstrates substantial four-electron reduction effects that have heretofore not been known in a conventional carbon material for catalyzing the two-electron reduction of an oxygen molecule.

By placing the electrode of the present invention at the intersection of the ion path and the oxygen path, it becomes possible to smoothly induce electrochemical reduction of oxygen at a small overvoltage (resistance). As a result, an electrochemical element can be provided that is capable of yielding a large electromotive force and a large current value.

Particularly, the electrode of the present invention becomes a substitute for platinum and other noble metal catalysts that constitute the conventional four-electron reduction catalysts, because the reduction of oxygen molecules essentially progresses with four electrons. It thereby becomes possible to provide an electrode that achieves all of the following advantages: 1) low cost; 2) no need to use a separator to divide the locations at which oxidation and reduction reactions are performed; 3) reducing catalyst inactivation due to poisoning or the like; and other advantages.

By using a charcoal-based material obtained by carbonizing a nitrogen-containing synthetic material as the support for the catalyst in the oxygen reduction electrode, it also becomes possible to reduce the quantity of platinum and other noble metal catalysts used, because the reduction reaction is electrochemically catalyzed by the carrier itself.

Furthermore, it is considered likely that functions will be retained whereby reduction in performance due to poisoning and the like of platinum or other noble metal catalysts is minimized, and it becomes possible to achieve an even better performance.

### INDUSTRIAL APPLICABILITY

According to the present invention, a highly stable oxygen reduction electrode that allows four-electron reduction to occur with a selectivity of about 100% in practical terms can be provided for the electrochemical reduction of oxygen. This type of oxygen reduction electrode can be used for the air electrode, oxygen electrode, or other component of an electrochemical element in which an oxygen reduction reaction occurs as the positive electrode reaction. For example, this electrode can be appropriately used in a zinc-air battery, aluminum-air battery, sugar-air battery, or other air battery; an oxygen hydrogen fuel cell, methanol fuel cell, or other fuel cell; an enzyme sensor, oxygen sensor, or other electrochemical sensor; or the like.

The electrode and manufacturing method of the present invention as described above are suitable for industrial-scale production, and are highly practical.

### EXAMPLES

The present invention is explained in more detail below using examples and comparative examples. However, the scope of the present invention is not limited by these examples.

### Example 1

Preparation of Test Electrodes 1 and 2

Polyacrylonitrile was used as a synthetic polymer containing nitrogen. This synthetic polymer was first carbonized at 800° C. in a nitrogen atmosphere, and then steam activated at 900° C. The resulting charcoal-based materials were used to prepare test electrodes 1 and 2, respectively. These charcoal-based materials were confirmed by x-ray analysis to contain nitrogen. In infrared spectroscopy, these charcoal-based materials exhibited an absorption peak caused by electron binding including nitrogen in a wave number range of from about 2000 cm⁻¹ to 2300 cm⁻¹ as characteristic absorption. These results confirm that these were not perfect charcoal consisting solely of carbon but charcoal-based materials derived from the molecular structure of the precursor before carbonization.

The resulting charcoal-based materials were pulverized to a maximum diameter of 10 μm or less. 25 μg of the resulting powder was dispersed in 5 μl of an ethanol solution of 0.05% by mass of proton-conductive Nafion (brand name “Nafion 112,” Dupont). This dispersion was dripped so as to cover the entire surface of a gas-permeable conductive base and hot-air dried to evaporate the ethanol, after which the same dispersion was dripped again and the ethanol evaporated to prepare test electrodes comprising the charcoal-based material and Nafion.

0.36 mm thick carbon paper (TGPH-120, Toray) was used as the gas-permeable conductive base. A waterproof carbon paper base obtained by holding a mixture of 1 part by weight carbon black particles and 0.1 parts by weight polytetrafluoroethylene (PTFE) binder on carbon paper to 2.25 mg/cm² and a non-waterproofed carbon base were used.

Test electrode 1 was obtained by coating the surface of the waterproof carbon paper by the aforementioned method with the charcoal-based material to 4.2 mg/cm². Test electrode 2 was obtained by forming the charcoal-based material by the aforementioned methods to 2 mg/cm² on the waterproof carbon paper base.

### Example 2

Preparation of Test Electrode 3

Acrylic fiber of polyacrylonitrile of the nitrogen-containing synthetic polymer as the main component was carbonized at 800° C. in a nitrogen atmosphere, and steam activated at 900° C. 4 parts by weight of the resulting charcoal-based material (the mean particle size of about 5 μm), 4 parts by weight of a lower manganese oxide (mixture of Mn₃O₄ and Mn₅O₈, the mean particle size of about 10 μm), 1 part by weight of carbon black and 0.2 parts by weight of a fluororesin binder (PTFE) were mixed together. A sheet was prepared from the resulting mixture using a conductive base of nickel-plated stainless gold mesh (thickness 0.15 mm, 25 mesh) as the core, and a fluororesin porous sheet (porosity about 50%, thickness 0.2 mm) was crimped to one side of this sheet to prepare test electrode 3 with a thickness of about 3 mm.

### Example 3

Preparation of Test Electrode 4

Acrylic fiber having polyacrylonitrile as the main component was used as the nitrogen-containing synthetic polymer. 5 parts by weight of this synthetic polymer and 2 parts by weight of zeolite powder were mixed with water as the solvent, and molded and solidified to obtain a mixture. This mixture was carbonized at 900° C. in a nitrogen atmosphere. Further activation treatment by steam was carried out at 900° C. to obtain activated charcoal. In the resulting charcoal-based material, the inside of the solid material consisted of a carbon component and an inorganic component. X-ray analysis was performed to investigate the elements. The results confirmed that nitrogen was contained in the carbon component, and that silicon (Si) and aluminum (Al) from the zeolite were contained in the inorganic component. The aforementioned charcoal-based material was pulverized to a maximum diameter of 20 ’m or less. 25 μg of the resulting powder was dispersed in 5 μl of an ethanol solution of 0.05% by mass Nafion. This dispersion was dripped so as to cover the entire surface of the waterproofed carbon paper base used in Example 1, and hot-air dried to evaporate the ethanol and prepare test electrode 4 comprising a charcoal-based material and Nafion. In this electrode the charcoal-based material was formed to 2 mg/cm².

### Example 4

Preparation of Test Electrode 5

Polyacrylonitrile was used as the nitrogen-containing synthetic polymer. This synthetic polymer was first carbonized at 800° C. in a nitrogen atmosphere, and steam activated at 900° C. to obtain a charcoal-based material. Next, this charcoal-based material was pulverized to a maximum diameter of 10 μm or less. The resulting powder was impregnated with platinum salts by immersing it in an ethanol solution of 3 mmol/L platinic chloride. This was then reduced by addition of sodium borohydride at room temperature to support the platinum. The platinum content was about 10% by mass. 25 μg of this charcoal-based material impregnated with platinum was dispersed in 5 μl of an ethanol solution of 0.05% by mass proton-conductive Nafion (brand name “Nafion 112,” Dupont). This dispersion was dripped to cover the entire surface of the waterproofed carbon paper base used in Example 1 and hot-air dried to evaporate the ethanol, after which the same dispersion was dripped again and the ethanol evaporated to prepare test electrode 5 comprising the charcoal-based material and Nafion. In this test electrode 5 the charcoal-based material was formed to 2 mg/cm². The amount of platinum was about 0.2 mg/cm².

### Example 5

Preparation of Test Electrode 6

Polyimide resin was used as the nitrogen-containing synthetic polymer. This polyimide resin was obtain by condensation polymerization from pyromellitic anhydride as the dicarboxylic anhydride and bis(4-aminophenyl)ether as the diamine compound. A sheet of this polyimide resin was first carbonized at 800° C. in a nitrogen atmosphere and then steam activated at 900° C. The resulting charcoal-based material was used to prepare test electrode 6. This charcoal-based material was confirmed by x-ray analysis to contain nitrogen. In the infrared spectroscopic analysis it exhibited an absorption peak caused by electron binding including nitrogen in a wave number range of from about 1600 cm⁻¹ to 1800 cm⁻¹ as characteristic absorption. These results confirm that this was not a perfect charcoal consisting solely of carbon but a charcoal-based material derived from the molecular structure of the precursor before carbonization.

The resulting charcoal-based material was pulverized to a maximum diameter of 10 μm or less. 25 μg of the resulting powder was dispersed in 5 μl of an ethanol solution of 0.05% by mass of proton-conductive Nafion (brand name “Nafion 112,” Dupont). This dispersion was dripped so as to cover the entire surface of a gas-permeable conductive base consisting of 0.36 mm-thick carbon paper (TGPH-120, Toray) and hot-air dried to evaporate the ethanol, after which the same dispersion was dripped again and the ethanol evaporated to prepare test electrode 6 comprising the charcoal-based material and Nafion. The charcoal-based material was formed to 2 mg/cm² on the carbon paper base.

### Comparative Examples

Preparation of Comparative Electrodes, 1, 2, 3, 4 and 5

25 μg of carbon black powder with 50% by mass supported platinum was dispersed in 5 μl of an ethanol solution of 0.05% by mass of proton-conductive Nafion (brand name “Nafion 112,” Dupont). This dispersion was dripped so as to cover the entire surface of a waterproof carbon paper base obtained by holding a mixture of 1 part by weight carbon black particles as the gas-permeable conductive base and 0.1 part by weight polytetrafluoroethylene (PTFE) powder to 2.25 mg/cm² on 0.36 mm-thick carbon paper (TGPH-120, Toray), and hot-air dried to evaporate the ethanol, after which the same dispersion was dripped again and the ethanol evaporated to prepare comparative electrode 1 with about 0.35 mg/cm² of platinum.

Comparative electrode 2 was prepared with about 0.2 mg/cm² platinum by the same process except that carbon black powder with 30% by mass supported platinum was used in place of the aforementioned carbon black.

The aforementioned waterproof carbon paper base (that is, a waterproof carbon paper base consisting of 0.36 mm-thick carbon paper (TGPH-120, Toray) and a mixture of 1 part by weight carbon black particles as the gas-permeable conductive base and 0.1 part by weight polytetrafluoroethylene (PTFE) powder held to 2.25 mg/cm² on the carbon paper) was used as comparative electrode 3, non-waterproofed carbon paper alone (TGPH-120, Toray itself) as comparative electrode 4, and an ethanol solution of proton-conductive Nafion containing none of the aforementioned charcoal-based material formed on a carbon paper base as comparative electrode 5.

### Example 6

Evaluation of Electrode Characteristics of Test Electrodes 1 and 2

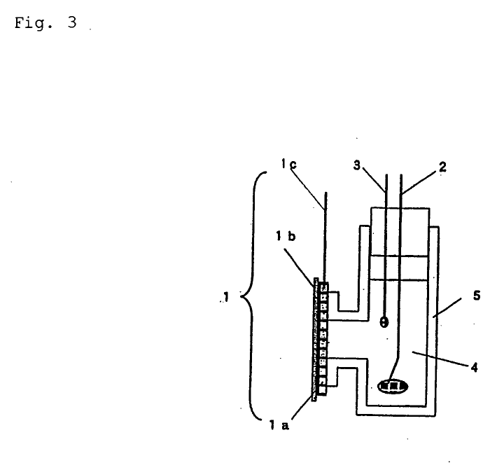

A three-electrode cell was assembled as shown in FIG. 3, and the oxygen reduction characteristics in the test electrodes were evaluated by the voltage-current characteristics. In FIG. 3, 1 is an air electrode, 1a is a test electrode or comparative electrode, 1b is a fluororesin porous sheet, 1c is an electrode lead, 2 is a counter electrode, 3 is a reference electrode, 4 is an electrolyte, and 5 is a glass cell with an opening 16 mm in diameter for positioning the air electrode. In air electrode 1, the surface of fluororesin porous sheet 1b is exposed to atmosphere at the opening of glass cell 5 as shown in FIG. 3, while the other surface is positioned so as to contact electrolyte 4 (that is, so as to contact test electrode or comparative electrode 1a). An 0.1 M phosphoric acid buffer solution with a pH of 7.0 was used as electrolyte 4. Platinum was used for counter electrode 2, and an Ag/AgCl (saturated KCl) electrode for reference electrode 3. Test electrode or comparative electrode 1a was brought tightly together with fluororesin porous sheet 1b.

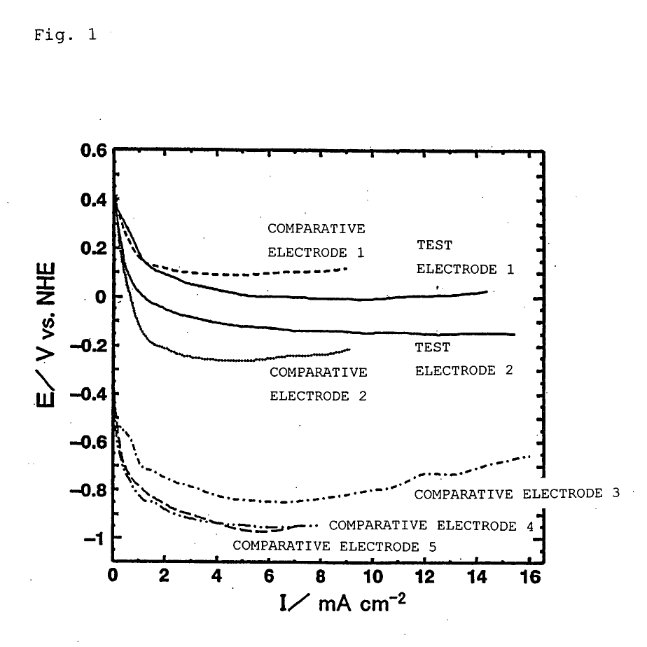

A comparison of the voltage-current characteristics of test electrodes 1 and 2 with those of the comparative electrodes used as air electrode 1 is shown in FIG. 1. The applied current was maintained for at least 10 minutes for purposes of measurement, and the electromotive force was expressed as a normal hydrogen electrode (NHE) standard corrected with cell resistance. In comparison with comparative electrode 3, which was made of waterproof carbon paper containing carbon black, test electrodes 1 and 2 had less excess voltage and higher electromotive force, and they provided about the same electromotive force as comparative electrodes 1 and 2, which were made with platinum catalysts. It is considered that characteristics comparable to the four-electron reduction reaction of platinum were obtained because the charcoal-based material used in the test electrodes effectively provided four-electron reduction, while only two-electron reduction of oxygen was achieved with conventional carbon materials. The electron numbers of the oxygen reduction reactions for these electrodes as measured by the rotating ring electrode method were from about 3.5 to 3.7, confirming that substantial four-electron reduction reactions were achieved.

### Example 7

Evaluation of Electrode Characteristics of Test Electrodes 3, 4, 5 and 6

As in example 6, a three-electrode cell was constructed with the configuration as shown in FIG. 3, and the oxygen reduction characteristics in the test electrodes were evaluated as voltage-current characteristics.

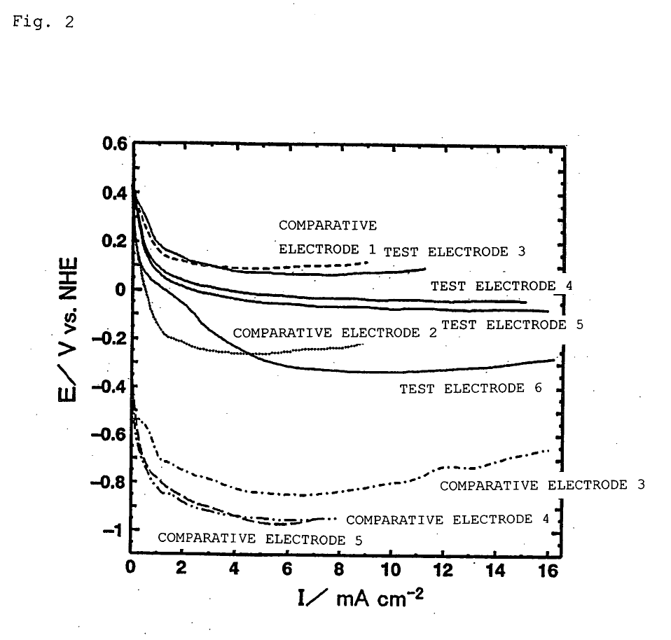

A comparison of the voltage-current characteristics of test electrodes 3, 4, 5 and 6 and the various comparative electrodes used as air electrode 1 is shown in FIG. 2. In comparison with comparative electrode 3, which was made of waterproof carbon paper containing carbon black, lower excess voltage and higher electromotive force were obtained with the test electrodes as in Example 6, indicating that four-electron reduction reaction of oxygen was substantially performed.

In the case of test electrode 3, because the lower oxide of manganese contained in the air electrode effectively decomposes the hydrogen peroxide produced by the two-electron reduction reaction of oxygen molecules, four-electron reduction reactions effectively occurred and the electromotive force was roughly equal to that obtained with platinum in comparative electrode 1.

In the case of test electrode 4, strong electromotive force was obtained by an electrochemical catalytic effect in the powder and granules even with a charcoal-based material formed by mold solidification using an inorganic compound. This suggests the potential for improving handling properties by forming the electrode into a molded body of charcoal-based material rather than as powder and granules for example.

In the case of test electrode 5, stronger electromotive force was obtained than with comparative electrode 2 in which the charcoal-based material was impregnated with the same amount of platinum. This was because in addition to the impregnated platinum the reducing effect of the charcoal-based material formed by carbonization of a nitrogen-containing polymer contributed to creating an efficient reduction reaction. Using this charcoal-based material as the catalyst carrier makes it possible use less of the expensive noble metal catalyst.

Comparing the retention times for electromotive force in the air electrode using test electrode 5 and comparative electrode 1, the time taken for electromotive force to decline by 10% was five times longer for test electrode 5 than for comparative electrode 1. One major factor in this decline in electromotive force is catalyst poison of the platinum catalyst. In test electrode 5 the decline in electromotive force is small because there is little platinum, but this effect cannot be simply attributed to catalyst poison because it is greater than the difference in amount of platinum (test electrode 5: comparative electrode 1=0.2:0.35), and other effects are thought to contribute. The mechanism are not clear, but it may be that catalyst poison of the platinum is reduced because the charcoal-based material effectively produces a four-electron reduction reaction of oxygen.

In test electrode 6, it was found that a similar four-electron reduction reaction is obtained even in a charcoal-based material formed by carbonization of a polyimide resin rather than a polyacrylonitrile resin.

### Example 8

Evaluation of Generator Cell Characteristics

Generator cell a was assembled having an air electrode comprising test electrode 1 of Example 1 as the plus electrode (positive electrode), the platinum of a counter electrode as the minus electrode (negative electrode) and an 0.1M phosphoric acid buffer solution of 100 mM dissolved glucose with a pH of 6.8 as the electrolyte. Generator cell b was assembled with the same positive electrode and negative electrode as in generator cell a and a pH 6.8 0.1 M phosphoric acid buffer solution of 3% by mass dissolved methanol as the electrolyte. Generator cells c and d were also assembled in the same manner except that the air electrode was replaced with platinum plate Pt as the positive electrode. The open circuit voltages of the various generator cells and the voltages of the cells after 10 hours' discharge at a fixed current value of 1 mA are shown in Table 1

TABLE 1

| | | | Open circuit | Voltage after 10 |
|---|---|---|---|---|
| Generator | Plus | | voltage | hr discharge |
| cell | terminal | Fuel | (volts) | (volts) |
| a | Air | Glucose | 0.85 | 0.77 |
| | electrode | | | |
| b | Air | Methanol | 0.73 | 0.65 |
| | electrode | | | |
| c | Platinum | Glucose | 0.43 | 0.28 |
| | plate | | | |
| d | Platinum | Methanol | 0.33 | 0.28 |
| | plate | | | |

With generator cells a and b in which an air electrode comprising the charcoal-based material of the present invention as an active component was used as the plus electrode, a 0.2-0.4 V higher discharge voltage was obtained than with generator cells c and d in which a platinum plate was used as the plus electrode. This is probably because a plus electrode consisting of an air electrode comprising a charcoal-based material formed by carbonization of a nitrogen-containing polymer material as an active component undergoes no oxidation reaction even when it contacts glucose or methanol directly, and yields a potential determined by the oxygen reduction reaction so that the generator cell produces a high voltage. In contrast, a plus electrode consisting of a platinum plate undergoes oxidation when it comes into direct contact with glucose or methanol, yielding a low potential determined by the oxidation reaction of glucose and methanol and the oxygen reduction reaction so that the generator cell produces a low voltage.

Glucose or methanol were used as fuel substances soluble in electrolyte, but a sugar other than glucose such as fructose, mannose, starch, cellulose or the like or ethanol, propanol, butanol, glycerol or the like can be used with the same effects. The same effects can also be obtained using a 0.1 N KOH aqueous solution or brine with 3% by mass dissolved NaCl as the electrolyte in place of the 0.1 M phosphoric acid buffer with a pH of 6.8.

### Example 9

Generator Cell Assembly

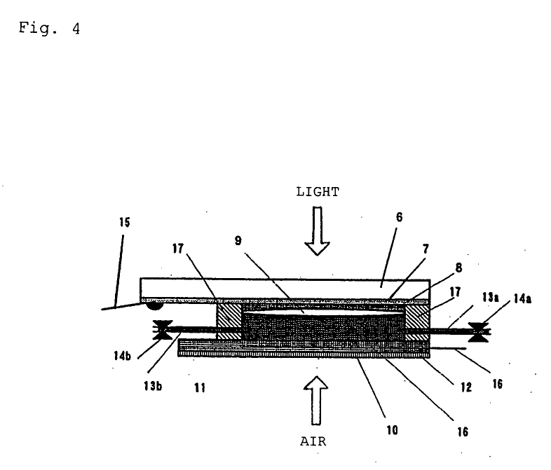

Generator cells A and B with the configuration shown in FIG. 4 were assembled.

In FIG. 4, air electrode 11, which functions as the positive electrode, was manufactured using the test electrode 1 obtained in Example 1 in the case of generator cell A. In FIG. 4, 15 is a negative electrode lead, 16 is a positive electrode lead, and 17 is a seal made of transparent silicon rubber.

In FIG. 4, the photocatalytic electrode which acts as the negative electrode consists of glass substrate 6, ITO thin film 7, titanium oxide (TiO₂) fine particle film 8, and dye molecule layer 9. A light-transmitting conductive substrate was prepared having indium-tin oxide (ITO) thin film 7 with a surface resistance of 10 ohm/cm² formed on 1 mm-thick glass substrate 6. An acetonitrile solution containing 30% by mass polyethylene glycol with 11% by mass dispersed TiO₂ particles having a mean particle size of 10 nm was applied by the dipping method to the aforementioned ITO thin film, which was then dried at 80° C. and baked for 1 hour in air at 400° C. TiO₂ fine particle film 8 was thus formed with a thickness of about 10 μm. Next, TiO₂ fine particle film 8 was dipped in ethanol having 10 mM dissolved ruthenium metal complex dye molecules 9 shown by the following chemical formula to impregnate TiO₂ fine particle film 8 with dye molecules 9. After being dipped in 4-tert-butylpyridine, this was washed in acetonitrile and dried to prepare the aforementioned photocatalytic electrode.

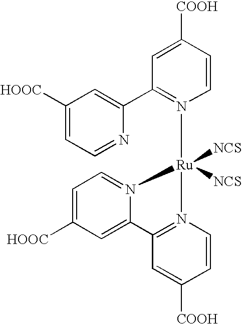

A product obtained by dissolving 5% by mass of fuel methanol, 5 mM nicotinamide nucleotide (NADH) coenzyme, 16.0 U/mL of alcohol dehydrogenase (ADH), 1.0 U/mL of aldehyde dehydrogenase (AlDH), and 0.3 U/mL of formate dehydrogenase (FDH) in a 0.1-M phosphoric acid buffer solution with a pH of 7.0 was used as the electrolyte solution/fuel solution 10. The electrolyte solution/fuel solution 10 was injected from the electrolyte/fuel inlet 13a and discharged from the electrolyte/fuel outlet 13b after electrical generation. Air was supplied to the inside of the power-generating cell from the outside through the oxygen-permeable water-repelling film 12.

The structure of the power-generating cell depicted in FIG. 4 will be described. The negative electrode side of this power-generating cell was primarily composed of the glass base 6, and the ITO thin film 7 was laminated onto the surface of the glass base 6. The negative electrode lead 15 was provided to the ITO thin film 7. The positive electrode side of the power-generating cell was primarily composed of the plate-shaped air electrode 11, and the oxygen-permeable water-repelling film 12 was laminated onto the surface of the air electrode 11. The positive electrode lead 16 extended from inside the air electrode 11. The power-generating cell was formed by bringing the surface of this glass base 6 to face the back surface of the plate-shaped air electrode 11, and fixing the glass base 6 and the air electrode 11 together with the seal 17 between them.

In the space between the glass base 6 and the air electrode 11, the electrolyte solution (or fuel) 10 was positioned next to the air electrode 11, and a particle thin film 8 in which particles consisting of titanium oxide were dispersed was positioned next to the glass base 6. The dye separation layer 9 was also sandwiched between the electrolyte solution (or fuel solution) 10 and the particle thin film 8.

An electrolyte solution/fuel solution inlet 13a and electrolyte solution/fuel outlet 13b passing through the seal 17 were also provided to the seal 17. Fluid valves 14a and 14b were provided to the electrolyte solution/fuel solution fill port 13a and electrolyte solution/fuel solution discharge port 13b, respectively. A configuration was adopted whereby the electrolyte solution (or fuel solution) 10 between the glass base 6 and air electrode 11 can be injected from the outside and discharged to the outside via the electrolyte solution/fuel inlet 13a and electrolyte solution/fuel outlet 13b.

Power-generating cell B was also fabricated so as to have the same structure as power-generating cell A, except that power-generating cell B used an air electrode fabricated using the test electrode 3 obtained in Example 2.

Operating characteristics of the power-generating cells After filling the power-generating cells with electrolyte solution/fuel solution, the cells were irradiated from the glass base 6 side with light of a sunlight simulator (AM 1.5, 100 mW/cm²), and the electromotive force (OCV) and voltage of the power-generating cells after discharge at a constant current of 100 μA for 20 minutes were measured. The OCV was 0.80 V in power-generating cell A and 0.65 V in power-generating cell B. The voltages of the power-generating cells after a 20-minute discharge were 0.75 V in power-generating cell A and 0.55 V in power-generating cell B. Thus, high electromotive force was obtained and high voltage was maintained even during discharge.

A battery comprising a photocatalyst electrode as the negative electrode of the power-generating cell and methanol as fuel is described in the present example, but even when zinc, magnesium, aluminum, or another metal is used as the negative electrode, a battery can be obtained as an electrochemical element having high electromotive force and high cell voltage during discharge by combining the negative electrode of the above metals with the oxygen reduction electrode according to the present invention.

1. A method for manufacturing an oxygen reduction electrode used in four-electron reduction of oxygen, the method comprising (1) a first step of obtaining a charcoal-based material by carbonizing a starting raw material comprising a nitrogen-containing synthetic polymer at a temperature of from 500° C. to 1000° C. in an atmosphere of 10% or less oxygen concentration by volume, and then subjecting the charcoal-based material to steam activation, and (2) a second step of producing the oxygen reduction electrode using an electrode material that contains the charcoal-based material.

2. The manufacturing method according to claim 1, wherein the nitrogen-containing synthetic polymer is made from at least one kind of monomer having one or more nitrogen atoms in the molecule.

3. The manufacturing method according to claim 1, wherein the nitrogen-containing synthetic polymer is at least one selected from the group consisting of a polyacrylonitrile, a polyimide, a polyamide, a polyurethane, a polyurea and a polyaniline.

4. The manufacturing method according to claim 1, wherein the atmosphere is an inert gas atmosphere.

5. The manufacturing method according to claim 1, wherein the oxygen reduction electrode is produced in the second step by forming the electrode material into a specific shape to obtain a formed body, and laminating or pressure-bonding the formed body to an electrically conductive base.

6. The manufacturing method according to claim 1, wherein the oxygen reduction electrode is produced in the second step by preparing a paste containing the electrode material, and coating the paste onto an electrically conductive base.

7. The manufacturing method according to claim 1, wherein an inorganic component is added to at least one of the starting material, the charcoal-based material and the electrode material.

8. The manufacturing method according to claim 7, wherein the inorganic component comprises at least one selected from the group consisting of manganese, silicon, aluminum, phosphorus, calcium, potassium and magnesium.

9. The manufacturing method according to claim 1, wherein the charcoal-based material exhibits the infrared absorption in the range of from about 3000 to 3500 cm⁻¹.

10. The manufacturing method according to claim 9, wherein the infrared absorption is based on stretching of nitrogen (N)-hydrogen (H).

11. The manufacturing method according to claim 1, wherein the charcoal-based material exhibits the infrared absorption in the range of from about 2000 to 2300 cm⁻¹.

12. The manufacturing method according to claim 11, wherein the infrared absorption is based on stretching of carbon (C)-nitrogen (N) of nitrile.

13. The manufacturing method according to claim 11, wherein the infrared absorption is based on stretching of nitrogen (N)=carbon (C)=nitrogen (N) of carbodiimide.

14. The manufacturing method according to claim 11, wherein the infrared absorption is based on stretching of carbon (C)=nitrogen (N).

15. The manufacturing method according to claim 1, wherein the charcoal-based material exhibits the infrared absorption in the range of from about 1600 to 1800 cm⁻¹.

16. The manufacturing method according to claim 15, wherein the infrared absorption is based on stretching of nitrogen (N)-carbon (C)=oxygen (O) of amide or imide.

17. The manufacturing method according to claim 1, wherein the charcoal-based material exhibits 1) the infrared absorption in the range of from about 3000 to 3500 cm⁻¹, 2) the infrared absorption in the range of from about 2000 to 2300 cm⁻¹ and 3), the infrared absorption in the range of from about 1600 to 1800 cm⁻¹.

18. The manufacturing method according to claim 1, wherein at least one type of metal and oxide thereof is added to at least one of the starting material, the charcoal-based material and the electrode material.

19. The manufacturing method according to claim 18, wherein the oxide is a lower oxide of manganese represented by the general formula MnO_{y}, wherein y is a number of oxygen atoms determined by the valence of manganese (Mn), and is less than two.
